(19) United States
(12) Patent Application Publication
(10) Pub. No.: US 2026/0051789 A1
(43) Pub. Date: Feb. 19, 2026

(54) DIRECT-DRIVE MODULAR ARC GENERATOR SYSTEMS AND METHODS

(71) Applicants: EOLIC CO., Dover, DE (US); UT-BATTELLE, LLC, Oak Ridge, TN (US)

(72) Inventors: Alfredo CALLE, Lima (PE); Vandana RALLABANDI, Knoxville, TN (US)

(21) Appl. No.: 19/223,651

(22) Filed: May 30, 2025

Related U.S. Application Data
(60) Provisional application No. 63/684,024, filed on Aug. 16, 2024.

(51) Int. Cl. H02K 7/18; H02K 1/16; H02K 1/17; H02K 1/2791

(52) U.S. Cl. CPC H02K 7/183; H02K 1/16; H02K 1/17; H02K 1/2791; H02K 2213/12

(57) ABSTRACT

An electrical direct-drive generator that extracts rotational motion from wind or water is described. One or more modular stators overlap with a portion of a rotor. Each modular stator includes multiple stationary coils wound around magnetic cores. The number of modular stators can be increased to increase the desired output. The low-speed rotation of the rotor relative to the stationary modular stator generates electricity without the need for a gearbox and/or additional stages of power conversion. As a result, the electrical generator has reduced system weight, reduced volume, increased efficiency, increased reliability, reduced cost, and other advantages.

### CROSS-REFERENCE TO RELATED APPLICATIONS

The present application claims priority to U.S. Provisional Application No. 63/684,024, entitled “Direct-Drive Modular Arc Generator Systems And Methods” filed on Aug. 16, 2024, which is specifically incorporated by reference herein in its entirety.

### STATEMENT REGARDING FEDERALLY SPONSORED RESEARCH AND DEVELOPMENT

The technologies described herein were developed with government support under Contract No. DE-AC05-00OR22725 awarded by the U.S. Department of Energy. The government has certain rights in the described technologies.

### FIELD

Aspects of the present disclosure relate to systems and methods for directly extracting rotational motion from a low-speed wind or hydro machine.

### BACKGROUND

Wind turbines convert the kinetic energy of wind into mechanical energy, which is then transformed into electrical energy through a generator. Blades capture the wind's kinetic energy, causing a rotor to spin. This rotational energy is transmitted through a low-speed shaft to a gearbox, which increases the rotational speed and transmits the energy to a high-speed shaft connected to a generator. The generator then converts the mechanical energy into electrical energy.

However, gearboxes in wind turbines can present challenges that may impact the overall efficiency, reliability, and cost-effectiveness of wind energy generation. One of the primary challenges with gearboxes is their mechanical complexity. Gearboxes contain multiple moving parts, such as gears and bearings, which are subject to significant mechanical stress and wear over time. This complexity often results in higher maintenance requirements and costs, as regular inspections, lubrication, and repairs are necessary to ensure reliable operation.

Gearbox failures are another concern in wind turbine operations. Such failures can lead to substantial downtime and repair costs, impacting the overall availability and economic viability of the wind turbine. Replacing or repairing a gearbox is a complex and expensive process that often requires specialized equipment and personnel. Additionally, the downtime associated with gearbox failures results in lost energy production, further reducing the efficiency and profitability of the wind turbine.

The mechanical losses within the gearbox may also contribute to reduced energy conversion efficiency. As mechanical energy is transmitted through the gearbox, friction and other losses can occur, diminishing the amount of energy available for conversion to electrical power. These losses can impact the overall efficiency of the wind turbine, particularly in lower wind speed conditions where maximizing energy capture is critical.

Moreover, gearboxes often add weight and size, complicating the design and construction of wind turbines. The additional weight and space required for the gearbox and associated components necessitate stronger and larger structures, increasing the material and construction costs of the wind turbine.

Further, the mechanical operation of gears and bearings often produces noise, which can be a concern in areas where noise pollution is regulated or near residential zones. Reducing gearbox noise typically involves additional engineering and design considerations, further complicating the turbine design process.

Turbine systems used for wind can be applicable to hydropower applications. Use of a gearbox for low-power hydro speeds also has similar considerations. It is with these observations in mind, among others, that the presently disclosed technology was conceived.

### SUMMARY

Implementations described and claimed herein address the forgoing by providing direct drive modular magnet arc generator systems and methods. Some implementations include a direct-drive arc generator having a plurality of blades. The plurality of blades radiate outward from a central axis. A ring-shaped rotor is operatively connected to the plurality of blades, with a center of the ring-shaped rotor disposed on the central axis. A plurality of permanent magnets of the ring-shaped rotor is arranged in alternating polarities. A generator stator is disposed in an arc of a circle and separated from the ring-shaped rotor by a gap. A center of the circle is disposed on the central axis. A plurality of windings is disposed in the arc of the circle.

Some implementations include a direct-drive arc generator having a plurality of blades. The plurality of blades radiate outward from a central axis. A rotor includes a ferromagnetic material and is operatively connected to the plurality of blades. The rotor includes a first portion comprising a ring and a second portion including a plurality of protrusions radiating outward at least one of axially or radially. A generator stator is disposed in an arc of a circle and includes a plurality of windings and a plurality of permanent magnets. A center of the circle is on the central axis, and the plurality of windings and the plurality of permanent magnets are disposed on the arc of the circle. The generator stator is separated from the rotor by a gap.

Some implementations include a method for generating energy including capturing energy using a direct-drive arc generator, the direct-drive arc generator having a plurality of blades radiating outward from a central axis, a rotor operatively connected to the plurality of blades and having a center disposed on the central axis, a plurality of permanent magnets of the rotor arranged in alternating polarities, and a generator stator disposed in an arc of a circle having a center of the circle disposed on the central axis and a plurality of windings disposed in the arc of the circle; and generating electricity by the plurality of windings from the energy produced by a rotation of the rotor relative to the generator stator.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example arc generator.

FIG. 2 illustrates an example stator module.

FIG. 3 illustrates an example arc generator.

FIG. 4 illustrates an example arc generator.

FIG. 5 illustrates an example arc generator.

FIG. 6 illustrates an example arc generator.

FIG. 7 illustrates an example arc generator.

FIG. 8 illustrates a portion of an example arc generator.

FIG. 9 illustrates an example arc generator.

FIG. 10 illustrates a portion of an example arc generator.

FIG. 11 illustrates an example method of generating electricity.

### DETAILED DESCRIPTION

Aspects of the present disclosure relate to systems and methods for directly extracting rotational motion from a low-speed machine, such as a wind or hydro machine. Generally, wind and hydro turbines that have a low-speed rotation rotor often use a gearbox, which increases the rotational speed for a generator to convert the rotational energy to electrical energy. However, the gearbox typically faces various challenges, including increased mechanical complexity, decreased reliability, and decreased efficiency. Thus, in some aspects, the systems and methods described herein generate electricity at a periphery of a rotating ring, instead of harnessing energy from a rotating central shaft. Stated differently, direct drive modular magnet arc generator systems and methods improve conversion of angular kinetic energy/rotational energy into electrical energy in a modular and direct manner, without a power transmission system linking a peripheral rotating ring and an electricity generation device.

Such direct drive modular magnet arc generator systems and methods eliminate use of a gearbox while still converting low-speed rotation rotor into electrical energy, thereby reducing maintenance costs, enhancing overall energy conversion efficiency, and providing other improvements that will be understood from the present disclosure. In some aspects, a generator includes a rotor, which may include permanent magnets and/or a magnetic core, that rotates against a stationary stator. The stationary stator includes windings of coil around magnetic cores. The stator may include permanent magnets. The low-speed rotation of the rotor induces a changing magnetic field that results in electric current generated by the windings. The stator may cover an arc rather than an entire circle. Hence, the generator described herein may be referred to as an arc generator.

Multiple stator modules may be used to increase electricity output. The use of multiple stator modules each connected to its own rectifier makes the generator fault tolerant. If one stator module and/or rectifier is faulty, power can still be delivered using the remaining modules. Further, when reduced power is available from the turbine, output power can be extracted from some of the modules. The multiple stator modules also reduce the electromagnetic forces occurring on the structure in case of a winding fault.

The generator may be a modular direct drive peripheral electricity generation device that includes a peripheral rotating ring. The ring may be a peripheral support element rotating around an axial shaft. Angular power may be produced by an external force coupled to the peripheral rotating ring. Permanent magnets may be attached to or otherwise embedded in the peripheral rotating ring providing interleaved polarities, and the polarity of their magnetic flux may be axial and/or radial to the shaft of the peripheral rotating ring. A plurality of electricity generation modules may be arranged around the peripheral rotating ring, along an arc segment, axially and/or radially in relation to the shaft of the peripheral rotating ring. Each electricity generation module of the generator may include a stator with static windings, such that rotation of the peripheral rotating ring generates rotational motion of the permanent magnets, which in turn produces rotating and oscillating magnetic fields of axial or radial flux orientation. Each electricity generation module may be independent in the function of generating electrical energy by electromagnetic induction. There may be an air gap separation between the permanent magnets and each stator with static windings. There may also be a controller connected to each electricity generation module that moves each electricity generation module closer to and/or further away from the electromagnetic induction fluxes generated by the permanent magnets of the peripheral rotating ring, thereby controlling the activation or deactivation of each electricity generation module.

In some aspects, the generator generates electricity through modularity for the use of the angular kinetic energy of a peripheral rotating ring, whose angular momentum is produced by an external force, coupled to the peripheral rotating ring, where the direct conversion of the angular kinetic energy into electricity is conducted at the periphery of the same peripheral rotating ring in question. The peripheral rotating ring may be the peripheral support of, for example, a turbine, or any other mechanism with angular momentum whether it is of horizontal shaft and/or vertical shaft.

Rotational energy/angular kinetic energy is directly proportional to the rotational inertia and the square of the magnitude of the angular velocity. Furthermore, given a constant angular velocity, the power capacity of the rotational mechanisms of electricity generation grows relative to (e.g., with the square of) the internal diameter of the electric stator, as well as with the length of the stator winding or lamination. In other words, the rated power of the electricity generator increases with the increase of the diameter of the peripheral rotating ring, which limits the diameter of the electric stator. In addition, if the angular velocity of the rotating ring were to increase, the rated power may also increase directly and proportionally.

The systems and methods of the present disclosure may transfer the traditional electricity generation capacity coupled to the central shaft of an electric generator to a peripheral rotating ring coupled to a power mechanism, thus directly capturing the rotational energy of the device, without the need to use a central shaft mechanism. In this regard, the presently disclosed technology improves conversion of angular kinetic energy into electrical energy, in a modular and direct manner, without the need for a power transmission device linking the peripheral rotating ring and the electricity generation device. Further, by bringing the energy generation from a central shaft to a peripheral rotating ring, the total magnetic induction capacity of the inner cylinder of the electric stator may grow in surface area, translating into a higher power rating. The total magnetic induction capacity may be determined by the product of the inner diameter of the stator, the length of the stator winding perpendicular to the magnetic field, and π.

The presently disclosed technology provides compact electricity generation modules around the peripheral rotating ring, connected in series or in parallel. This may generate a specific amount of electricity in relation to the energy consumption and available power, thus avoiding oversized or undersized systems. Due to the modular capability of the generator, each electrical module is configured to operate individually, facilitating the activation and deactivation of each electrical module on demand, depending on the electrical consumption and/or available power at a given moment.

Modulation of the electrical signal, elimination of power intermittency, voltage transformation, systems of activation or deactivation of the electrical modules, among others, can be of the type normally used by power electronics and/or other electrical subsystems. With a modular direct drive peripheral generation device described herein, the presently disclosed technology eliminates the power transmission system and implements a modular generation system capable of adapting to the prevailing energy needs and available power, in addition to increasing the flexibility of the system in the face of variations in demand and increasing the resilience and fault tolerance of the system in the face of adverse events.

The modularity does not limit the rotational speed of the rotor, but rather the generation modules may be adapted to the rotational speed of the rotor without restraint, thereby achieving the maximum or near maximum possible efficiency at all or most times. An electrical system is not needed to protect the stator from contact with the rotor, such that the systems do not consume the energy produced by the rotor itself, resulting in greater efficiency. Only an arc of the same circle is occupied as opposed to the full circle, where the generating capacity is matched to the actual angular power of the rotor, and not the other way around. The proposed arc-shaped modular design may allow a correct dimensioning of the generator, a lower consumption of materials, and a lower weight of the device.

In some aspects, the systems and methods generate axial flux induction magnetic fields and/or radial flux induction magnetic fields in relation to the shaft of the peripheral rotating ring. In addition to the magnetic flux orientation, electricity may be generated through induction or reluctance generator schemes.

The systems and methods described herein may include peripherally supported turbines where the direct capture of rotational energy is conducted at the periphery of the turbine itself, which is driven by a moving fluid such as water vapor, wind energy, water energy, and/or the like.

The systems and methods described herein provide several advantages, including but not limited to modularity, increased resilience, increased efficiency, decreased start-up power, increased capacity factor, and reduction of mechanical losses, among other benefits. For example, with the modular design of the electricity generation device, it is possible to activate and/or deactivate each module on demand individually, so that the energy generation device can be actively adapted to different operating scenarios, whether these are caused by energy demand or by the variability or intermittency of the power received by the peripheral rotating ring.

Further, because of the modularity, the entire generation device may achieve increased resilience to deal with unforeseen random failures in the electricity generation modules because the output of one of the generation modules does not affect the capacity of the remaining modules. Thus, the generation device may manage to continue to operate continuously. In contrast, a central shaft generating device may have to cease operation in the event of an adverse event, because such devices have a single linked generator. Because the modules can be activated and/or deactivated on demand, the generation device as a whole may operate in a staggered and optimal manner, where each generation module is specifically activated after passing a predetermined threshold and related to the power level available at that time. In this way, each discrete interval of available power may be linked to an optimal generation curve, the aggregation of which ends up being superior to the individual generation curve of the maximum capacity of a device using a single generator.

Because the modules may be activated on demand, the generation device can be started with a lower start-up power because the maximum capacity of the device remains dormant, reducing the minimum power to start generating power. A direct application of this advantage may be related to wind turbines, which can start rotating with a lower initial wind speed because only a first-generation module is in active mode, thus reducing the initial start-up force required. Because of the higher resilience, higher efficiency, and lower start-up speed, the generator may exhibit increased operating hours and thus a higher capacity factor. Further, because the generator has no contact with the peripheral rotating ring, a mechanical power transmission system may be eliminated since the power from the peripheral rotating ring may be transferred directly to the modules of the generator, thus eliminating the mechanical losses resulting from the use of a drivetrain. Other advantages will be readily apparent from the present disclosure to those skilled in the art.

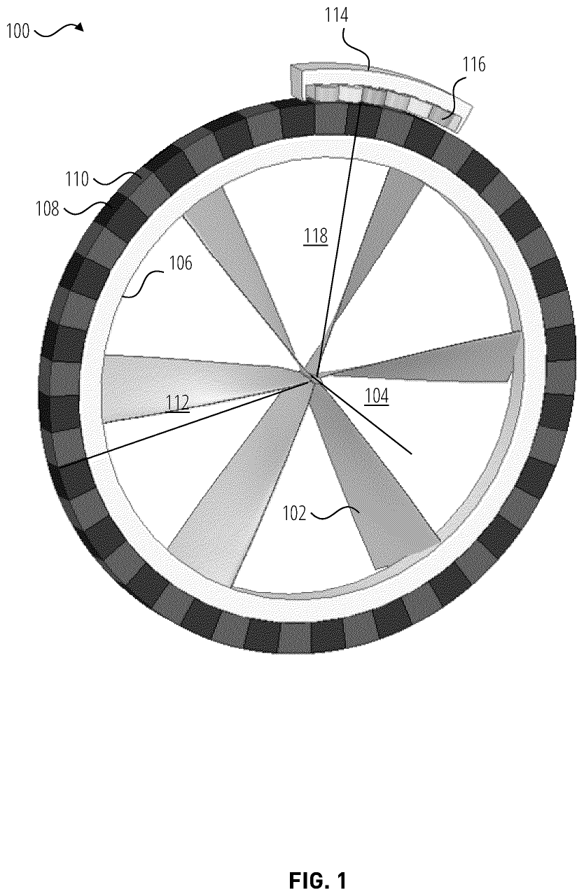

To continue a detailed described, reference is made to FIG. 1, which shows an example arc generator 100. Arc generator 100 may include a plurality of blades, including blade 102. The blades may rotate about central axis 104.

A rotor core 106 may be connected to the plurality of blades. Rotor core 106 may be magnetic. Connected to rotor core 106 may be a permanent magnet rotor, including first magnet 108 and second magnet 110. First magnet 108 and second magnet 110 may be adjacent magnets. First magnet 108 may be oriented for one polarity, and second magnet 110 may be oriented for the opposite polarity. Rotor core 106 may be optional. The rotor may have a radius 112, extending from central axis 104 to the edge of the rotor, which may be a permanent magnet.

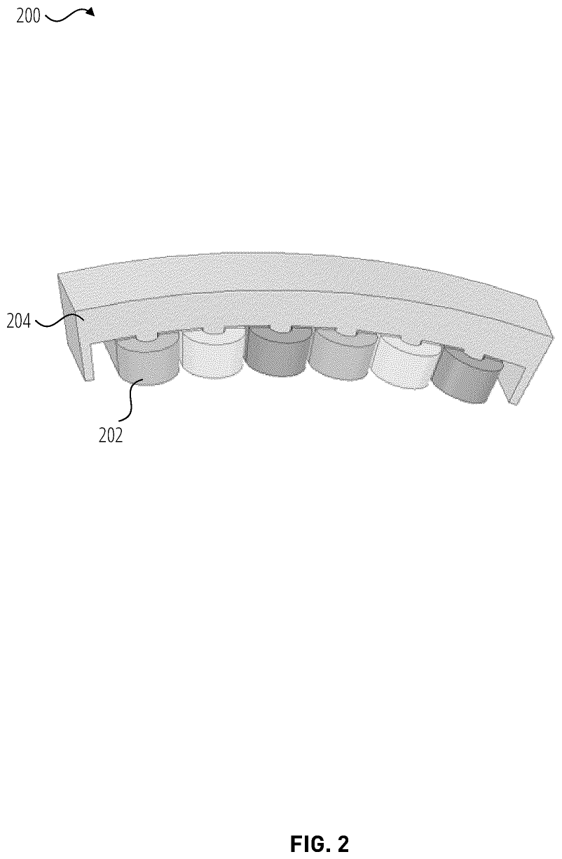

Arc generator 100 may include a generator stator 114. In some implementations, generator stator 114 is stationary while the rotor rotates. Generator stator 114 may include multiple windings including winding 116. Generator stator 114 is described in more detail with respect to FIG. 2.

Generator stator 114 may be positioned radially outward from the rotor and the plurality of blades. Generator stator 114 may be spaced away from the rotor such that the rotor can rotate freely without physical interference from generator stator 114. The spacing can account for expansion of either the rotor or the generator stator 114. The distance from the inner edge of generator stator 114 to central axis 104 may be radius 118. The width of the spacing may be the difference between radius 112 and radius 118.

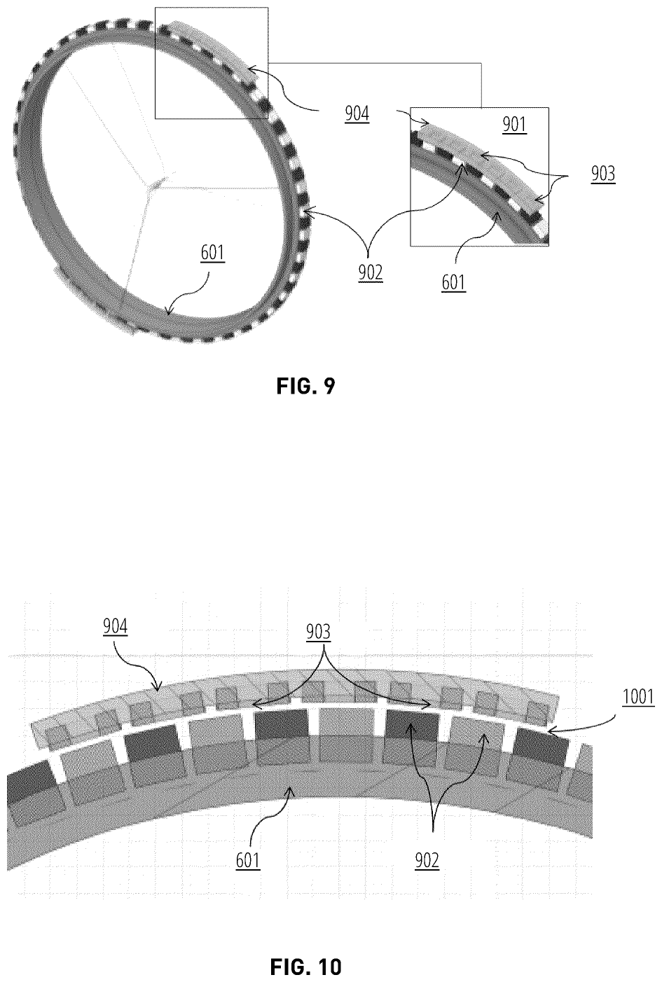

Features described with respect to FIG. 1 may be similar to a radial flux peripheral generation device 604 described with respect to FIG. 9. For example, rotor core 106 may be substantially similar to peripheral rotating ring 601. First magnet 108 and second magnet 110 may be substantially similar to permanent magnets 902. Generator stator 114 may be substantially similar to peripheral generation radial module 602 or stator 904.

FIG. 2 shows an example stator module 200, such as a generator stator. A module includes a plurality of windings, including winding 202. In FIG. 2, the shadings of the windings indicate the electrical phase. Winding 202 may include a coil of a conductive wire. The coil may be wound around a magnetic core. The coil may be covered by an insulator. Stator module 200 may include support 204, which may be configured to hold the plurality of windings and may be the core of the stator. A single stator module 200 may span an arc of a circle. The number of stator modules can be increased depending on the desired electricity output. The ability to increase or decrease the number of stator modules as needed allows for the arc generator to be modular.

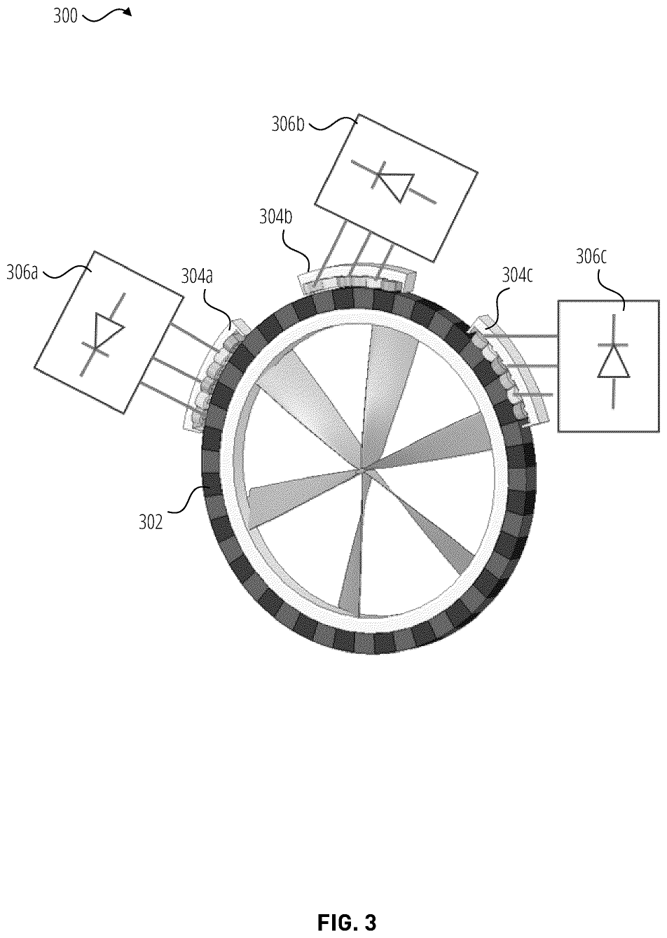

FIG. 3 shows an example arc generator 300. Arc generator 300 may include a rotor 302, as described with arc generator 100. Around rotor 302 may be stator modules 304a, 304b, and 304c. In FIG. 3, stator modules 304a, 304b, and 304c are distributed over the top half of rotor 302, but in some examples, stator modules 304a, 304b, and 304c may be distributed evenly around rotor 302 (e.g., every 120 degrees). In electrical communication with each stator module is a rectifier (e.g., rectifiers 306a, 306b, and 306c). Rectifiers 306a, 306b, and 306c convert alternating current to direct current. Each stator module may also be in electrical communication with a respective load.

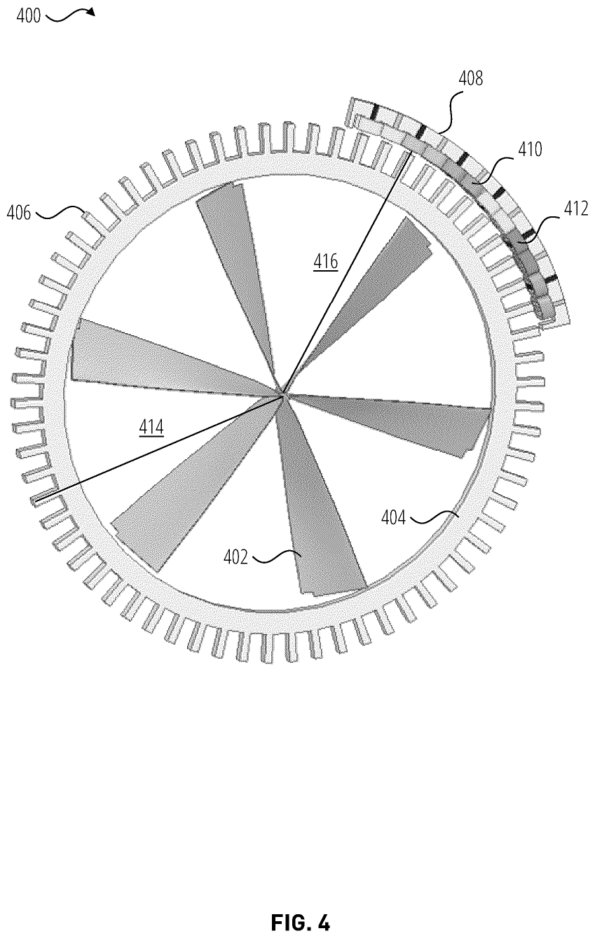

FIG. 4 illustrates an example arc generator 400 that does not include a rotor with a permanent magnet. Arc generator 400 may include a plurality of blades, including blade 402. The plurality of blades may be similar to any plurality of blades described herein.

Arc generator 400 may include a rotor 404. Rotor 404 does not include permanent magnets but may be a magnetic core. The magnetic core may include teeth (e.g., tooth 406) and slots between the teeth. The teeth may be identical. The teeth may be distributed evenly around the rotor. The distance from the center of the rotor to the end of the teeth is radius 414.

Arc generator 400 may include stator module 408. Stator module 408 may include a plurality of windings, including winding 410. In addition, stator module 408 may include a plurality of permanent magnets, including permanent magnet 412. The permanent magnets may magnetize rotor 404. The rotation of rotor 404 may induce a changing magnetic field, which may result in an electric current generated by the windings. Arc generator 400 may include additional stator modules.

A distance from the inner edge of stator module 408 (e.g., the inner edge of a winding or a permanent magnet) to the center of the rotor may be radius 416. The spacing between the stator module 200 and the teeth may be the difference between radius 414 and radius 416.

Arc generator 400 involves fewer permanent magnets than configurations where the rotor includes permanent magnets (e.g., arc generator 100, arc generator 300, and arc generator 500). Fewer permanent magnets may be an advantage if the cost of a permanent magnet is high.

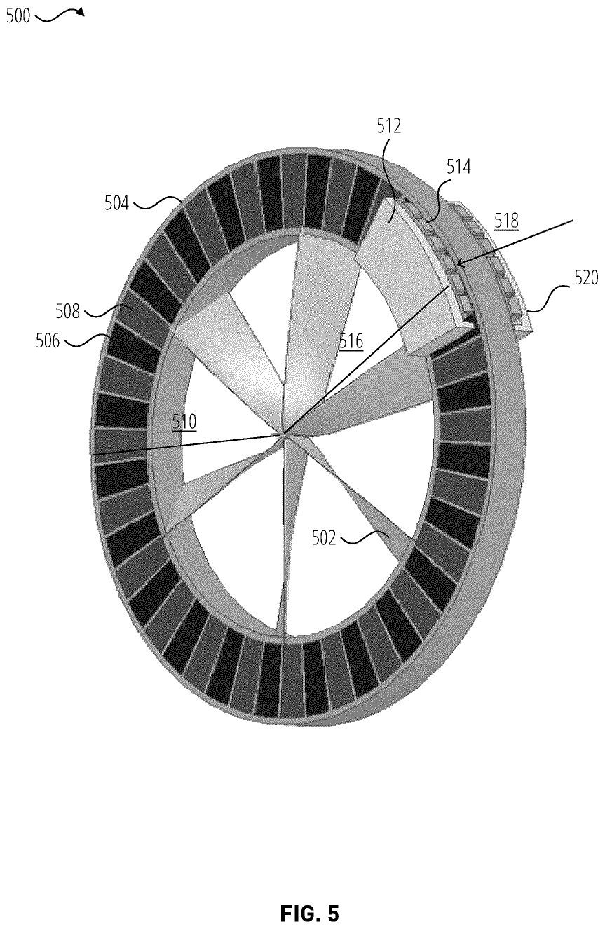

FIG. 5 illustrates an example arc generator 500 where stator module 512 is oriented axially away from rotor 504 instead of radially away.

Arc generator 500 may include a plurality of blades, including blade 502. The plurality of blades may be connected to rotor 504. Rotor 504 may include a plurality of permanent magnets, including first permanent magnet 506 and second permanent magnet 508. In some examples, first permanent magnet 506 and second permanent magnet 508 are adjacent magnets being oriented with opposite or alternating polarities.

Stator module 512 may include a plurality of windings, including winding 514. The outer edge of stator module 512 may be separated from the center of rotor 504 by radius 516. The outer edge of stator module 512 may be a winding, the core, or another part of stator module 512. Stator module 512 may be separated from the permanent magnets by spacing 518. A surface of stator module 512 (e.g., a surface of winding 514) may be parallel to a surface of rotor 504 (e.g., a surface of a permanent magnet).

In some examples, arc generator 500 includes a second stator module, stator module 520. Stator module 520 may be identical to stator module 512 but oriented as a mirror image of stator module 512. Stator module 520 may be on an opposite side of rotor 504 as stator module 512.

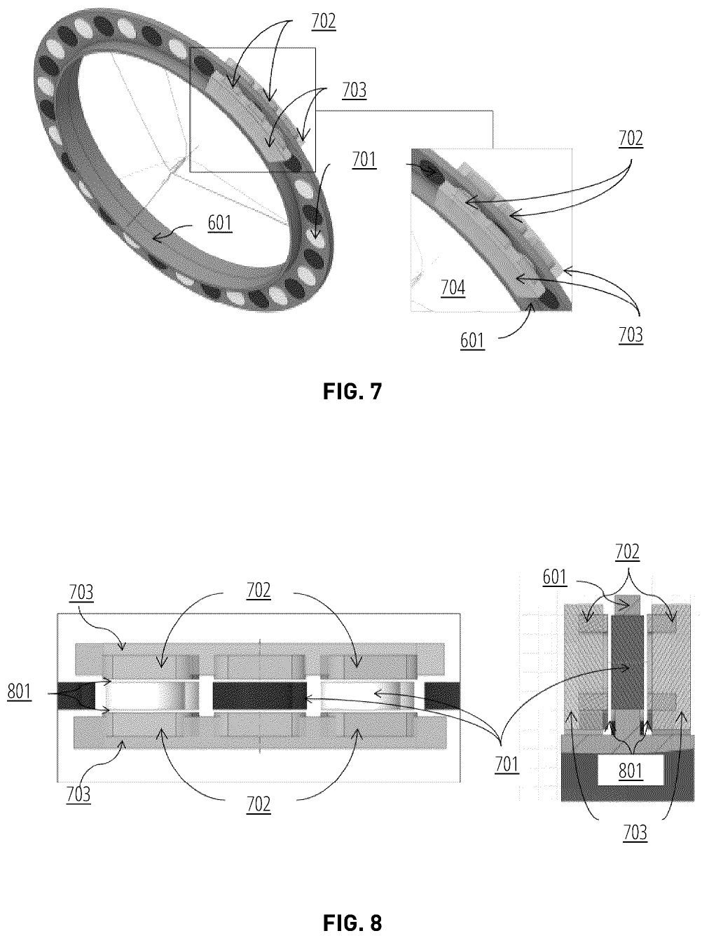

Aspects of FIG. 5 may be similar to axial flow axial flux peripheral generation device 605 and FIG. 7. For example, first permanent magnet 506 and second permanent magnet 508 may be similar to permanent magnets 701. Stator module 512 may be similar to stator 703.

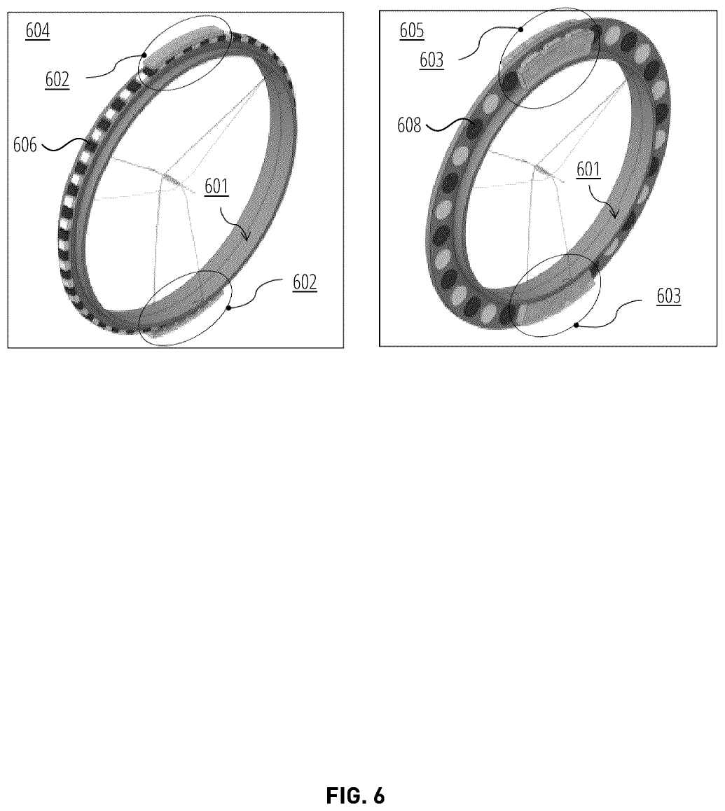

Referring to FIG. 6, in some examples, the axial flux peripheral generation device 605 and radial flux peripheral generation device 604 include individual modules, capable of generating electric energy by electromagnetic induction independently, where each module may be arranged along an arc segment of the total circumference of the generator. The axial flux module of the generator may be termed peripheral generation axial module 603. The radial flux module of the generator may be called peripheral generation radial module 602. FIG. 6 shows peripheral rotating ring 601, permanent magnets 606, and permanent magnets 608.

The electromagnetic induction capacity of an electrical generation device may grow proportionally and directly with the internal diameter of the stator. The modules of the generator, as shown in FIG. 6, may allow the correct dimensioning of the generation capacity of the device through the adaptation and use of a preestablished series of modules, where each module shall operate independently, and where the energy generated by all the modules may be aggregated, managed, controlled and/or synchronized by a central power electronics system.

Turning to FIG. 7, the axial peripheral generation module 704 may include a peripheral rotating ring 601, permanent magnets 701, axial module winding 702, and axial module stator 703, which together form the unit of a modular device for the generation of electrical energy by means of axial flux magnetic induction.

Permanent magnets 701 may be attached to and/or otherwise embedded in peripheral rotating ring 601, and the polarity of their magnetic flux may be axial to the shaft of the peripheral rotating ring 601.

The winding 702 may be coupled to stator 703, which may remain static, so that the rotation of the peripheral rotating ring 601 generates a rotational movement of the permanent magnets 701, which in turn produce rotating magnetic fields, whose fluxes interact with winding 702 attached to stator 703, where the fluctuation of the magnetic fields produced by the permanent magnets 701 induces an electric current in winding 702.

FIG. 8 shows a cross section of an axial peripheral generation module with permanent magnets 701, the winding 702, and the stator 703. Air gap 801 is characterized as the air space between the stator 703 and permanent magnets 701.

In some examples, for the arrangement of an axial peripheral generation module, it is possible to arrange two winding windings 702 and two stators 703 for the same set of permanent magnets 701, which may allow a more compact module to meet the specific needs of the generation device.

Referring to FIG. 9, the radial peripheral generation module 901 may include peripheral rotating ring 601, permanent magnets 902, winding 903, and stator 904, which together form the unit of a modular device for electric energy generation by radial flux magnetic induction.

The permanent magnets 902 may be attached to and/or otherwise embedded in peripheral rotating ring 601, and the polarity of their magnetic flux may be radial to the shaft of peripheral rotating ring 601.

Winding 903 may be coupled to the stator 904, which may remain static, so that the rotation of the peripheral rotating ring 601 generates a rotational movement of permanent magnets 902, which in turn produce rotating magnetic fields, whose fluxes interact with the winding 903 attached to stator 904, where the fluctuation of the magnetic fields produced by the permanent magnets 902 induces an electric current in winding 903.

FIG. 10 shows a cross section of the radial peripheral generation module having permanent magnets 902, winding 903, and the stator 904. Air gap 1001 is characterized as the air space between stator 904 and permanent magnets 902.

Furthermore, it is possible to arrange only one winding 903 and one stator 904 for the same set of permanent magnets 902.

As described herein, example magnet rotor systems may include a direct-drive arc generator. The generator may be part of a wind turbine or hydropower turbine. The generator may include a plurality of blades. The plurality of blades may radiate outward from a central axis.

The generator may include a ring-shaped rotor (e.g., peripheral rotating ring 601). The ring-shaped rotor may be operatively connected to the plurality of blades. Movement in the blades may move the rotor at the same angular velocity. The rotor may include a plurality of permanent magnets. The plurality of permanent magnets may be arranged in alternating polarities. The number of permanent magnets on the rotor may be from 2 to 10, 10 to 50, 50 to 100, 100 to 200, or over 200. The center of the ring-shaped rotor may be on the central axis (e.g., central axis 104).

The generator also may include a generator stator (e.g., stator module 200). The generator stator may be disposed in an arc of a circle. The circle may be defined by an inner edge, an outer edge, a midpoint, and/or the like of the generator stator relative to the center of the circle. The center of the circle may be on the central axis. The generator stator may include a plurality of windings. The plurality of windings may be disposed on the arc of the circle. Each winding may be arranged as a coil of conductive material (e.g., copper, aluminum). The number of turns in the windings may vary from 10 to 50, 50 to 100, 100 to 200, or over 200. The windings may be configured to have an electric current induced upon a changing magnetic field induced by the spinning rotor.

The generator stator may be separated from the ring-shaped rotor by a gap. The gap may have a constant width. The width may be from 1 to 5 mm, 5 to 10 mm, 10 to 20 mm, 20 to 30 mm, 30 to 50 mm, 50 to 100 mm, or over 100 mm.

Some examples include a plurality of generator stators. Each generator stator of the plurality of generator stators may be disposed on the arc of the circle. The multiple generator stators may not span the entire 360 degrees of the circle. The multiple generator stators may or may not be evenly distributed around the circle. The number of generator stators may be adjusted depending on the desired electricity output. For example, for a 3-phase generator, the number of stator windings is a multiple of 3. The spacing between the stator teeth (ws) and the rotor poles (wr) may have the following relationships: ws=0.833 wr; ws=1.33 wr; ws=0.888 wr, ws=1.33 wr, ws=1.11 wr, etc. Those skilled in the art will recognize that similar relationships for generators with a higher number of phases can be derived in this manner.

A rectifier in electrical communication with the generator stator may be included. With multiple generator stators, each generator stator may be in electrical communication with a respective rectifier of multiple rectifiers (e.g., rectifiers 306a, 306b, and 306c).

Example magnet rotor systems may include a direct-drive arc generator similar to arc generator 100 and/or arc generator 300. The generator stator(s) may be positioned radially outward from the rotor. The outer edge of the ring-shaped rotor may be characterized by a first radius (e.g., radius 112). An inner edge of the generator stator may be characterized by a second radius (e.g., radius 118). The second radius may be greater than the first radius. The first radius and the second radius may separately and independently be in a range from 1 to 10 cm, 10 cm to 100 cm, 100 cm to 1 m, 1 m to 10 m, or over 10 m. The plurality of windings may be characterized by a plurality of longitudinal axes. The plurality of longitudinal axes may intersect the central axis. Each winding of the plurality of windings may be cylindrical or prismatic, with or without a concentric curvilinear shape relative to the axis of rotation. Multiple generator stators may be disposed on the arc of the circle (e.g., FIG. 3). The circle may be characterized by a radius that is greater than the radius of the outer edge of the ring-shaped rotor.

Other examples may be similar to arc generator 500, where the generator stators may be displaced from the plane of the rotor. The generator stators may be disposed in any axial direction while remaining in a plane parallel to the plane of the rotor. A first plane may include the plurality of windings. A second plane may include the gap. The first plane may be parallel to the second plane.

The outer edge of the stator may be even with the outer edge of the rotor (e.g., as shown with stator module 512 and rotor 504 in FIG. 5) or may be closer to the central axis than the outer edge of the rotor. An outer edge of the ring-shaped rotor may be characterized by a first radius. An outer edge of the generator stator may be characterized by a second radius. The second radius may be less than or equal to the first radius.

The generator may include a second generator stator. The second generator stator (e.g., stator module 520) may be on an opposite side of the ring-shaped rotor as the first generator stator. The second generator stator may overlap the first generator stator. The second generator stator may be aligned or completely overlap the first generator stator (e.g., stator module 512 and stator module 520). Multiple generator stators may be arranged in overlapping pairs. The pairs may or may not be evenly distributed around the rotor. The second generator stator may be disposed on an arc of a circle with a center on the central axis. The second generator stator may be separated from the ring-shaped rotor by another gap. A plane including the gap associated with the first generator stator may be parallel to a plane with the gap associated with the second generator stator.

The generator may exclude a drivetrain or gearbox, allowing the blades to rotate at low speeds to generate electricity.

Examples of non-magnet rotor systems may include a direct-drive arc generator with a rotor that does not include permanent magnets (e.g., similar to arc generator 400). The generator may include a plurality of blades. The plurality of blades may radiate outward from a central axis.

The generator may include a rotor. The rotor may be of a ferromagnetic material and not a permanent magnet. For example, the rotor may include iron, nickel, cobalt, or alloys thereof (e.g., stainless steel). The rotor may be operatively connected to the plurality of blades.

The rotor may include a first portion including a ring. The rotor may include a second portion, which includes a plurality of protrusions (e.g., tooth 406) radiating outward. The protrusions may radiate outward axially or radially from the central axis. The first portion may be closer to the central axis than the second portion. The plurality of protrusions may be distributed evenly around the ring. The plurality of protrusions may be rectangular-shaped. The number of protrusions may be from 5 to 10, 10 to 50, 50 to 100, or greater than 100. The number of protrusions may be based on the outer diameter of the rotor and the span of each winding in a generator stator.

The generator may also include a generator stator. The generator stator (e.g., stator module 408) may be disposed in an arc of a circle (e.g., a circle with radius from radius 416 to a radius to the outer edge of stator module 408). The center of the circle may be on the central axis. The generator stator may include a plurality of windings and a plurality of permanent magnets. The number of permanent magnets in the stator may be equal to the number of stator teeth. The plurality of windings and the plurality of permanent magnets may be disposed on the arc of the circle. The plurality of windings may be characterized by a plurality of longitudinal axes. The plurality of longitudinal axes may intersect the central axis. The generator stator may be separated from the ring-shaped rotor by a gap. The plurality of windings and the plurality of permanent magnets may be distributed such that for a three phase machine, the ratio of the spacing between the protrusions (wr) and the spacing between the stator teeth (ws) is given as: ws=0.8 wr or ws=1.166 wr or ws=0.916 wr. Other distributions are contemplated.

The generator may include a plurality of generator stators. Each generator stator may be disposed on the arc of the circle. The multiple generator stators may not span the entire 360 degrees of the circle. The configuration of the generator stators and the rotor may be similar to those described for any arc generator described herein, except that the rotor does not include permanent magnets. The generator stators may be disposed radially or axially from the rotor plane that includes the protrusions.

The generator stator may be located past the circumference defined by the rotor, similar to arc generator 400. The generator stator may be located radially outward from the rotor. The outer edge of the rotor may be characterized by a first radius. The outer edge of the rotor may be defined by the end of the protrusions farthest from the central axis. The inner edge of the generator stator may be characterized by a second radius. The second radius (e.g., radius 416) may be greater than the first radius (e.g., radius 414).

In some examples, the generator stator may be displaced axially from the rotor, similar to arc generator 500 (with the rotor being the rotor of arc generator 400 with no permanent magnets). A plane including the stator or the gap may be parallel to the rotor plane including the plurality of protrusions. The generator stators may be displaced from the rotor plane in any axial direction with the generator stators remain in a plane parallel to the rotor plane. The rotor's protrusions may span axially as well. The outer edge of the rotor may be characterized by a first radius. The outer edge of the generator stator may be characterized by a second radius. The second radius may be less than or equal to the first radius.

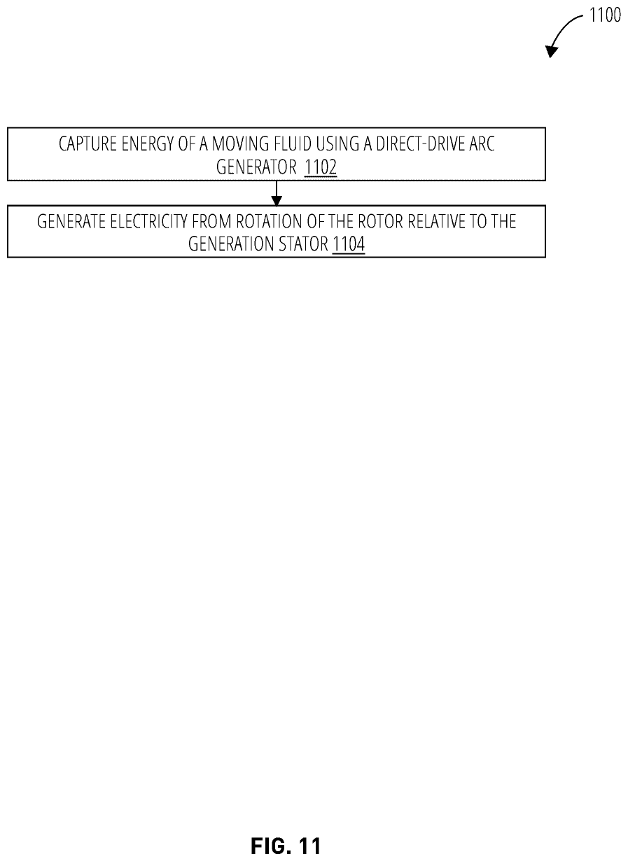

FIG. 11 shows an example method 1100 of generating electricity. At block 1102, method 1100 captures energy of a moving fluid using a direct-drive arc generator. The direct-drive arc generator may include any arc generator described herein, including arc generator 100, arc generator 300, arc generator 400, and arc generator 500. The fluid may include air or water.

At block 1104, method 1100 generates electricity from rotation of the rotor relative to the generator stator. The rotation of the rotor may be at low speeds. For example, the rotor may spin at 50-500 RPM. As an example, the electricity generated may be 1-100 kW.

In some examples, an electrical generator to extract rotational motion from wind or water. One or more modular stators overlap with a portion of a rotor. Each modular stator includes multiple stationary coils wound around magnetic cores. The number of modular stators can be increased to obtain the desired output. The low-speed rotation of the rotor relative to the stationary modular stator generates electricity without the need for a gearbox and/or additional stages of power conversion. As a result, the electrical generator has reduced system weight, reduced volume, increased efficiency, increased reliability, reduced cost, and other advantages.

In some examples, the direct-drive arc generator includes a plurality of blades. The plurality of blades may radiate outward from a central axis. The generator may also include a ring-shaped rotor with a plurality of permanent magnets. The ring-shaped rotor may be operatively connected to the plurality of blades. The plurality of permanent magnets may be arranged in alternating polarities. The center of the ring-shaped rotor may be on the central axis. The generator may also include a generator stator. The generator stator may be disposed in an arc of a circle. The center of the circle may be on the central axis. The generator stator may include a plurality of windings. The plurality of windings may be disposed in the arc of the circle. The generator stator may be separated from the ring-shaped rotor by an airgap.

In some examples, the direct-drive arc generator includes a plurality of blades. The plurality of blades may radiate outward from a central axis. The generator may also include a rotor of a ferromagnetic material. The rotor may be operatively connected to the plurality of blades. The rotor may include a first portion, the first portion including a ring. The rotor may include a second portion having a plurality of protrusions radiating outward from the central axis. The generator may also include a generator stator. The generator stator may be disposed in an arc of a circle. The center of the circle may be on the central axis. The generator stator may include a plurality of windings and a plurality of permanent magnets. The plurality of windings and the plurality of permanent magnets may be disposed on the arc of the circle. The generator stator may be separated from the ring-shaped rotor by an airgap.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the present disclosure. The upper and lower limits of these smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included in the present disclosure.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular examples. Functionality may be separated or combined in blocks differently in various examples of the disclosure or described with different terminology. These and other variations, modifications, additions, and improvements may fall within the scope of the disclosure as defined in the claims that follow.

What is claimed is:

1. A system comprising:
a direct-drive arc generator having a plurality of blades, the plurality of blades radiating outward from a central axis;
a ring-shaped rotor operatively connected to the plurality of blades, the ring-shaped rotor having a center disposed on the central axis;
a plurality of permanent magnets of the ring-shaped rotor arranged in alternating polarities;
a generator stator disposed in an arc of a circle, a center of the circle disposed on the central axis, the generator stator separated from the ring-shaped rotor by a gap; and
a plurality of windings of the generator stator, the plurality of windings disposed in the arc of the circle.

2. The system of claim 1, wherein:
an outer edge of the ring-shaped rotor including a first radius,
an inner edge of the generator stator including a second radius, and
the second radius is greater than the first radius.

3. The system of claim 1, wherein:
the plurality of windings including a plurality of longitudinal axes, and
the plurality of longitudinal axes intersect the central axis.

4. The system of claim 1, wherein each winding of the plurality of windings is at least one of cylindrical or prismatic.

5. The system of claim 1, wherein:
a first plane comprises the plurality of permanent magnets,
a second plane comprises the gap, and
the first plane is parallel to the second plane.

6. The system of claim 1, wherein the generator stator is a first generator stator and the system further comprises:
a second generator stator on an opposite side of the ring-shaped rotor from the first generator stator, the second generator stator overlapping the first generator stator.

7. The system of claim 1, further comprising a rectifier in electrical communication with the generator stator.

8. The system of claim 1, wherein the generator stator is a first generator stator in a plurality of generator stators, and each generator stator of the plurality of generator stators is disposed on the arc of the circle.

9. The system of claim 1, wherein the gap has a constant width.

10. The system of claim 1, wherein the direct-drive arc generator is part of a wind turbine.

11. A system comprising:
a direct-drive arc generator having a plurality of blades, the plurality of blades radiating outward from a central axis;
a rotor comprising a ferromagnetic material, the rotor is operatively connected to the plurality of blades,
a first portion of the rotor including a ring;
a second portion of the rotor including a plurality of protrusions radiating outward at least one of axially or radially;
a generator stator disposed in an arc of a circle, a center of the circle disposed on the central axis, the generator stator is separated from the rotor by a gap; and
a plurality of windings and a plurality of permanent magnets of the generator stator disposed on the arc of the circle.

12. The system of claim 11, wherein the plurality of protrusions is distributed evenly around the ring.

13. The system of claim 11, wherein the plurality of protrusions are rectangular-shaped.

14. The system of claim 11, wherein:
an outer edge of the rotor includes a first radius,
an inner edge of the generator stator includes a second radius, and
the second radius is greater than the first radius.

15. The system of claim 14, wherein:
the plurality of windings includes a plurality of longitudinal axes, and
the plurality of longitudinal axes intersect the central axis.

16. The system of claim 11, wherein:
a first plane comprises the plurality of protrusions,
a second plane comprises the gap, and
the first plane is parallel to the second plane.

17. The system of claim 11, wherein the generator stator is a first generator stator in a plurality of generator stators, and each generator stator of the plurality of generator stators is disposed on the arc of the circle.

18. A method for generating energy, the method comprising:
capturing energy using a direct-drive arc generator, the direct-drive arc generator having a plurality of blades radiating outward from a central axis, a rotor operatively connected to the plurality of blades and having a center disposed on the central axis, a plurality of permanent magnets of the rotor arranged in alternating polarities, and a generator stator disposed in an arc of a circle having a center of the circle disposed on the central axis and a plurality of windings disposed in the arc of the circle; and
generating electricity by the plurality of windings from the energy produced by a rotation of the rotor relative to the generator stator.

19. The method of claim 18, wherein the generator stator is a first generator stator, and further comprising increasing the electricity generated by including a second generator stator on an opposite side of the rotor from the first generator stator, the second generator stator overlapping the first generator stator.

20. The method of claim 19, further comprising converting alternating current to direct current using one or more rectifiers.
